(19) United States
(12) Patent Application Publication
(10) Pub. No.: US 2025/0246358 A1
(43) Pub. Date: Jul. 31, 2025

(54) COIL MODULE FOR ELECTROMAGNETIC MICROSPEAKER AND MANUFACTURING METHOD THEREOF

(71) Applicant: Otowahr Technology Inc., Hsinchu City (TW)

(72) Inventors: Yu-Min Fu, Hsinchu City (TW); Tung-Yu Wu, Hsinchu City (TW); Tse-Chih Tang, Hsinchu City (TW)

(73) Assignee: Otowahr Technology Inc., Hsinchu City (TW)

(21) Appl. No.: 19/035,316

(22) Filed: Jan. 23, 2025

Related U.S. Application Data
(60) Provisional application No. 63/624,805, filed on Jan. 25, 2024.

(51) Int. Cl. H01F 27/28; H01F 41/02

(52) U.S. Cl. CPC H01F 27/2804; H01F 41/02; H01F 2027/2809

(57) ABSTRACT

A coil module includes a first substrate, a first coil, a second substrate, a second coil, and a via. The first substrate includes a plurality of caves. The first coil is embedded into the first substrate. The second substrate is deployed on a lower surface of the first substrate, and the second substrate includes a plurality of concave parts which form a plurality of cavities with the plurality of caves respectively. The second coil is embedded into the second substrate. The via is embedded into the first substrate, and the first coil is electrically connected with the second coil through the via.

### CROSS-REFERENCE TO RELATED APPLICATION

This application claims the benefit of U.S. provisional application Ser. No. 63/624,805, filed on Jan. 25, 2024, the entire contents of which are hereby incorporated by reference.

### BACKGROUND

### Technical Field

The present disclosure relates to a coil module and a manufacturing method thereof, and in particular, to a coil module capable of producing sound and a manufacturing method thereof.

### Related Art

MEMS speaker is a miniaturized audio device with smaller size, better sound quality, and lower power consumption suitable for smartphones, headphones, or other portable electronic devices. Compared to traditional moving-coil speakers, the MEMS speaker involves microfabrication technology to achieve a high-precision structure on the micron scale. In addition, the manufacturing process of the MEMS speaker is highly automated, which facilitates mass production to reduce the unit price, thus becoming an important development direction of current audio technology.

### SUMMARY

In view of this, the applicant provides a coil module, which includes a first substrate, a first coil, a second substrate, a second coil, and a via. The first substrate includes a plurality of caves. The first coil is embedded into the first substrate. The second substrate is deployed on a lower surface of the first substrate, and the second substrate includes a plurality of concave parts which form a plurality of cavities with the plurality of caves respectively. The second coil is embedded into the second substrate. The via is embedded into the first substrate, and the first coil is electrically connected with the second coil through the via.

The applicant further provides a coil module, which includes a first substrate, a first coil, a second substrate, a second coil, and a via. The first substrate includes a plurality of caves. The first coil is deployed on an upper surface of the first substrate. The second substrate is deployed on a lower surface of the first substrate, and the second substrate includes a plurality of concave parts which form a plurality of cavities with the plurality of caves respectively. The second coil is embedded into the second substrate. The via is embedded into the first substrate, and the first coil is electrically connected with the second coil through the via.

The applicant further provides a manufacturing method of a coil module, which includes: deploying a first matrix; drilling a hole on the first matrix to form a via; forming a first conduction layer on a lower surface of the first matrix, where the first conduction layer includes a first coil, and the first coil covers the via; forming a second conduction layer on an upper surface of the first matrix, where the second conduction layer includes a second coil and a buffer layer, and the second coil covers the via; forming an extension matrix on the lower surface of the first matrix to cover the first coil, and forming a first substrate together with the first matrix; forming a second substrate on an upper surface of the first substrate; drilling a hole on the first substrate at a position corresponding to the buffer layer; and removing the buffer layer.

### BRIEF DESCRIPTION OF THE DRAWINGS

FIG. 1A is a schematic top view of a coil module according to Embodiment 1 of the present application.

FIG. 1B is a schematic cross-sectional view of a coil module according to Embodiment 1 of the present application.

FIG. 2A is a schematic cross-sectional view of a coil module according to Embodiment 2 of the present application.

FIG. 2B is a schematic cross-sectional view of a coil module according to Embodiment 3 of the present application.

FIG. 2C is a schematic cross-sectional view of a coil module according to Embodiment 4 of the present application.

FIG. 3A is a schematic cross-sectional view of a coil module according to Embodiment 5 of the present application.

FIG. 3B is a schematic cross-sectional view of a coil module according to Embodiment 6 of the present application.

FIG. 3C is a schematic cross-sectional view of a coil module according to Embodiment 7 of the present application.

FIG. 3D is a schematic cross-sectional view of a coil module according to Embodiment 8 of the present application.

FIG. 4 is a schematic hierarchical view of a coil module according to Embodiment 1 of the present application.

FIG. 5A is a schematic top view of a coil module according to Embodiment 9 of the present application.

FIG. 5B is a schematic top view of a coil module according to Embodiment 10 of the present application.

FIG. 5C is a schematic top view of a coil module according to Embodiment 11 of the present application.

FIG. 5D is a schematic top view of a coil module according to Embodiment 12 of the present application.

FIG. 5E is a schematic top view of a coil module according to Embodiment 13 of the present application.

FIG. 6A is a schematic cross-sectional view of a coil module according to Embodiment 14 of the present application.

FIG. 6B is a schematic cross-sectional view of a coil module according to Embodiment 15 of the present application.

FIG. 6C is a schematic cross-sectional view of a coil module according to Embodiment 16 of the present application.

FIG. 7A and FIG. 7B are flowcharts of manufacturing of a coil module according to some embodiments of the present application.

FIG. 8, FIG. 9, FIG. 10A, FIG. 10B, FIG. 11A, FIG. 11B, FIG. 11C, FIG. 12, FIG. 13, FIG. 14A, FIG. 14B, FIG. 15, FIG. 16A, FIG. 16B, and FIG. 17 are schematic cross-sectional views of a manufacturing process of a coil module according to some embodiments of the present application.

FIG. 18 is a flowchart of manufacturing of a coil module according to some other embodiments of the present application.

### DETAILED DESCRIPTION

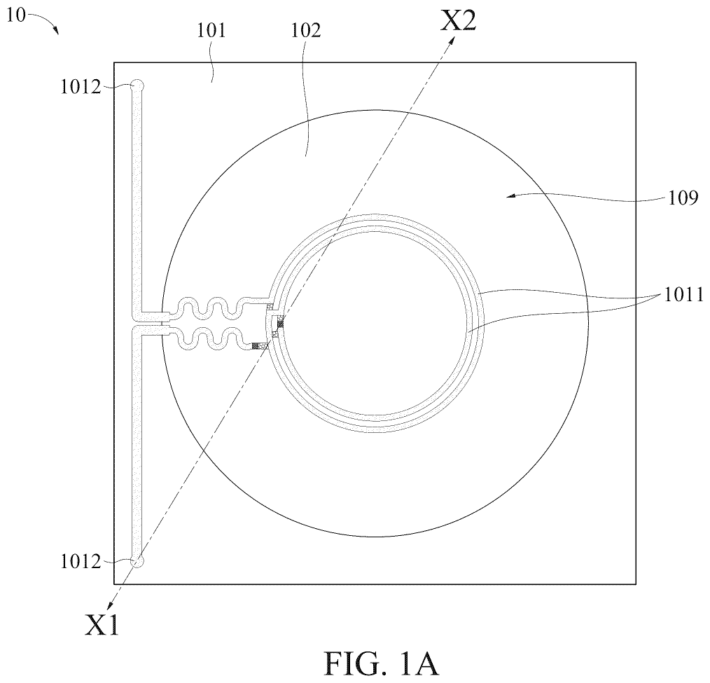

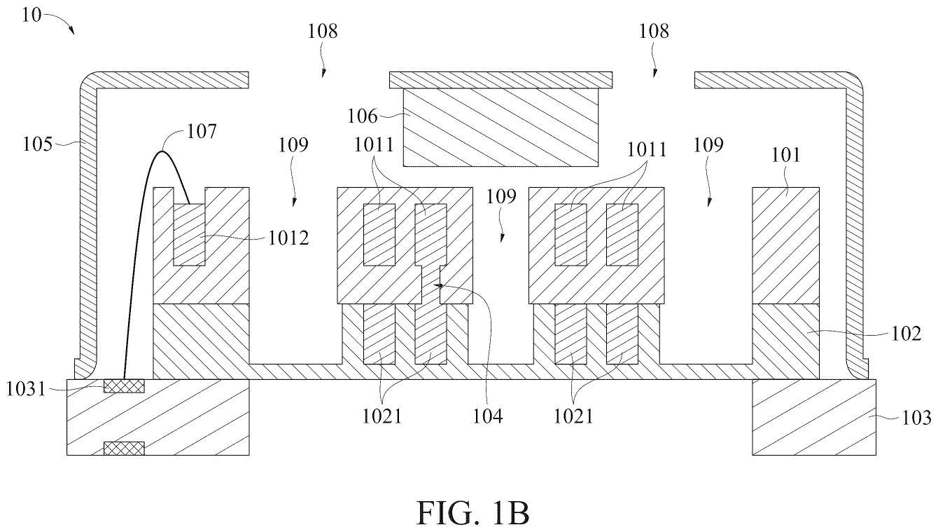

FIG. 1A is a schematic top view of a coil module according to Embodiment 1 of the present application, please refer to FIG. 1A. In the present embodiment, a coil module 10 includes a first substrate 101, a second substrate 102, and cavities 109. The first substrate 101 is provided with a first coil 1011 and a pad 1012. In the present embodiment, the first coil 1011 is a coil formed by two connected circles and includes an inner circle (i.e., a first sub-coil) and an outer circle (i.e., another first sub-coil). In other embodiments, the first coil 1011 may have other coil numbers or shapes. The second substrate 102 is covered below the first substrate 101, and the cavities 109 are at cave positions on the first substrate 101. Therefore, the second substrate 102 not covered by the first substrate 101 can be observed from a top view through the cavities 109. The cavities 109 may be deployed in and/or out of an area surrounded by the first coil 1011. The pad 1012 is electrically connected with the coil 1011, and the pad 1012 may be electrically connected with other electronic elements so as to guide a current into or out of the first coil 1011.

FIG. 1B is a schematic cross-sectional view of a coil module according to Embodiment 1 of the present application, please refer to FIG. 1B. FIG. 1B is a schematic cross-sectional view taken in a section line X1-X2 direction shown in FIG. 1A. In the present embodiment, the coil module 10 includes the first substrate 101, the second substrate 102, a third substrate 103, a lid 105, and a hard magnet 106. The first substrate 101 is deployed on an upper surface of the second substrate 102, and the second substrate 102 is deployed on an upper surface of the third substrate 103. The lid 105 is deployed on the upper surface of the third substrate 103 and forms a closed space with the third substrate 103. The hard magnet 106 is connected to an inner surface of the lid 105. The first substrate 101, the second substrate 102, and the hard magnet 106 are accommodated in the closed space.

The first substrate 101 includes the first coil 1011 and the pad 1012. In the present embodiment, the first coil 1011 of the coil module 10 includes the inner circle and the outer circle which jointly form four cross sections of the first coil 1011 shown in FIG. 1B. The first coil 1011 is enclosed within the first substrate 101. The first substrate 101 is partitioned into different blocks by the cavities 109. However, as shown in FIG. 1A, the first coil 1011 and the pad 1012 in FIG. 1B are electrically connected with each other. A material of the first substrate 101 can be selected from the group consisting of silicon, polyimide (PI), rubber, plastic, polymer, resin, wood, ceramic, glass, paper and a combination thereof.

The second substrate 102 includes a second coil 1021. In the present embodiment, the second coil 1021 of the coil module 10 includes an inner circle (i.e., a second sub-coil) and an outer circle (i.e., another second sub-coil) which jointly form four cross sections of the second coil 1021 shown in FIG. 1B. The second coil 1021 is enclosed within the second substrate 102 and located below the first coil 1011. In the present embodiment, different from the first substrate 101, the second substrate 102 is not partitioned into different blocks by the cavities 109, and the second substrate 102 is of a completely connected layered structure. Therefore, by observing the cavities 109 from a top-view perspective shown in FIG. 1A, the second substrate 102 at a bottom part can be observed. The second coil 1021 in FIG. 1B is electrically connected, and in addition, the second coil 1021 is electrically connected with the first coil 1011 and the pad 1012 through a conductor in a via 104. A material of the second substrate 102 may be a polymer which can be selected from the group consisting of polydimethylsiloxane (PDMS), polyimide, graphene, poly-para-xylylene and a combination thereof. The materials of the first coil 1011 and the second coil 1021 may be conductive materials such as metal, alloy, or conductive polymers. A material of a metal coil can be selected from the group consisting of copper, silver, gold, aluminum and a combination thereof.

The third substrate 103 includes a pad 1031 (i.e., a second pad), and the pad 1031 is electrically connected with the pad 1012 (i.e., a first pad) of the first substrate 101, or electrically connected with other electronic elements. In the present embodiment, the third substrate 103 is a double-faced substrate of which an upper surface and a lower surface are both provided with the pad 1031. The pad 1031 on the upper surface is connected with the pad 1012 of the first substrate 101 through a bonding wire 107, and the pad 1031 on the lower surface can serve as a pin of a packaging structure which is favorable for being welded to an external circuit board. A wire (not shown in the figure) may be deployed inside the third substrate 103 to connect a plurality of pads 1031. The third substrate 103 is provided with an open hole to expose the second substrate 102. Therefore, when the second substrate 102 vibrates, the produced sound can be transmitted outwards through the open hole of the third substrate 103. A material of the third substrate 103 can be selected from the group consisting of bakelite plate, glass fiber, copper foil, silicon, rubber, plastic, polymer, resin, wood, ceramics, glass, paper and a combination thereof.

The lid 105 is configured to cover and package the above-mentioned structure. In the present embodiment, the lid 105 includes holes 108, and the holes 108 are beneficial for air to enter and exit from the closed space formed by the lid 105 and the third substrate 103, so as to achieve an effect of sound wave transmission. In the present embodiment, the open hole and/or the holes 108 of the third substrate 103 can be used as sound production holes, and when the second substrate 102 vibrates, sound can be transmitted outwards through the open hole and/or the holes 108 of the third substrate 103. The number of the holes 108 can be configured according to requirements. A material of the lid 105 can be selected based on a resonance requirement of the coil module 10 for generating different sound frequencies. The material of the lid 105 can be selected from the group consisting of metal, plastic, ceramic, glass and a combination thereof. In some embodiments, the lid 105 is made of a magnetic material, so as to achieve a magnetic conduction effect.

The hard magnet 106 is configured to generate a magnetic field, and the first coil 1011 and the second coil 1021 bear a magnetic force when a current passes, so that the first substrate 101 and the second substrate 102 vibrate. In the present embodiment, the first coil 1011 and the second coil 1021 are annular coils, and the hard magnet 106 is cylindrical and is deployed on axes of the annular coils. A material of the hard magnet 106 may be an alloy containing iron, cobalt, and nickel, or an oxide thereof. For example, the hard magnet 106 may be a ferrite, an aluminum-nickel-cobalt magnet, a samarium-cobalt magnet, or a neodymium-iron-boron magnet.

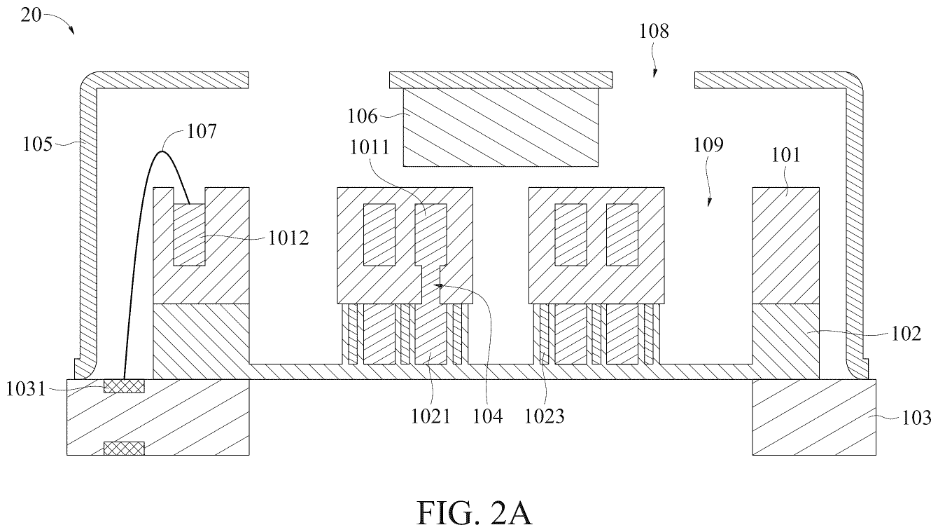

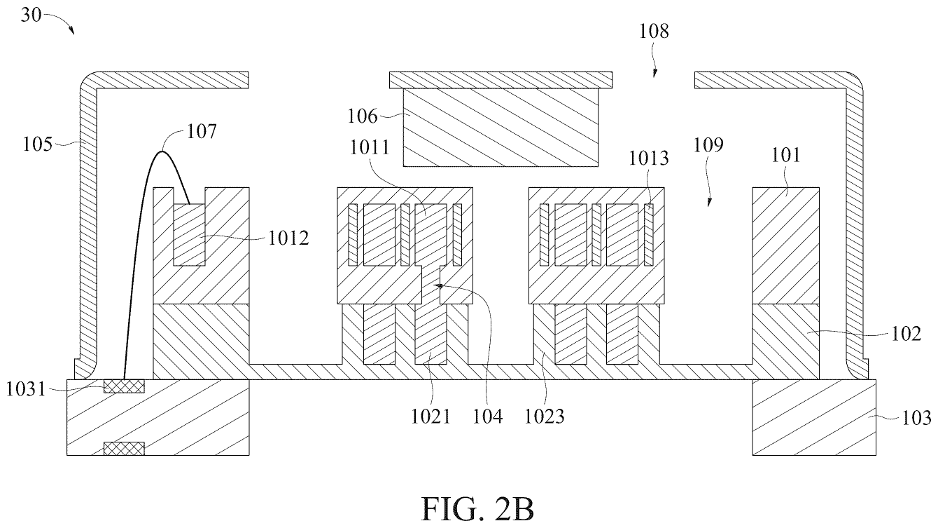

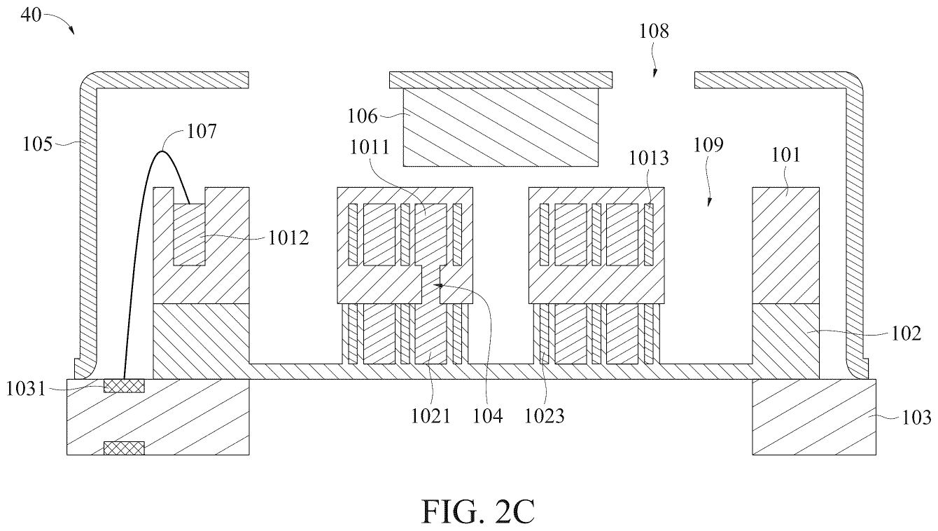

FIG. 2A is a schematic cross-sectional view of a coil module according to Embodiment 2 of the present application, please refer to FIG. 2A. In the present embodiment, a second substrate 102 of a coil module 20 includes a second coil 1021 and second soft magnets 1023. The second soft magnets 1023 are deployed inside, outside, or between coils of the second coil 1021, and the second soft magnets 1023 can be deployed around the second coil 1021. The second soft magnets 1023 are configured to guide the direction of the magnetic field produced by the hard magnet 106, so that magnetic lines are concentrated near the second soft magnets 1023, and the magnetic force borne by the second coil 1021 is enhanced. Therefore, the sound pressure level (SPL) of sound produced by vibration of the second substrate 102 is improved.

FIG. 2B is a schematic cross-sectional view of a coil module according to Embodiment 3 of the present application, please refer to FIG. 2B. In the present embodiment, a first substrate 101 of a coil module 30 includes a first coil 1011, a pad 1012, and first soft magnets 1013. The first soft magnets 1013 are deployed inside, outside, or between coils of the first coil 1011, and the first soft magnets 1013 can be deployed around the first coil 1011. The first soft magnets 1013 are configured to guide the direction of the magnetic field produced by the hard magnet 106, so that magnetic lines are concentrated near the first soft magnets 1013, and the magnetic force borne by the first coil 1011 is enhanced. Therefore, because the first substrate 101 is connected with the second substrate 102, the SPL of sound produced by vibration of the second substrate 102 is improved.

FIG. 2C is a schematic cross-sectional view of a coil module according to Embodiment 4 of the present application, please refer to FIG. 2C. In the present embodiment, a first substrate 101 of a coil module 40 includes a first coil 1011, a pad 1012, and first soft magnets 1013, and a second substrate 102 includes a second coil 1021 and second soft magnets 1023. The first soft magnets 1013 are deployed inside, outside, or between coils of the first coil 1011, and the first soft magnets 1013 can be deployed around the first coil 1011. The second soft magnets 1023 are deployed inside, outside, or between coils of the second coil 1021, and the second soft magnets 1023 can be deployed around the second coil 1021. The first soft magnets 1013 and the second soft magnets 1023 are configured to guide the direction of the magnetic field produced by the hard magnet 106, so that the magnetic lines are concentrated near the first soft magnets 1013 and the second soft magnets 1023, and the magnetic force borne by the first coil 1011 and the second coil 1021 is enhanced. Therefore, the SPL of the sound produced by the vibration of the second substrate 102 is improved. Compared with Embodiment 2 and Embodiment 3, the magnetic lines of the coil module 40 in Embodiment 4 are more concentrated, and therefore the produced sound achieves better SPL performance. Materials of the first soft magnets 1013 and the second soft magnets 1023 may be alloy containing iron, cobalt, and nickel, or oxide thereof.

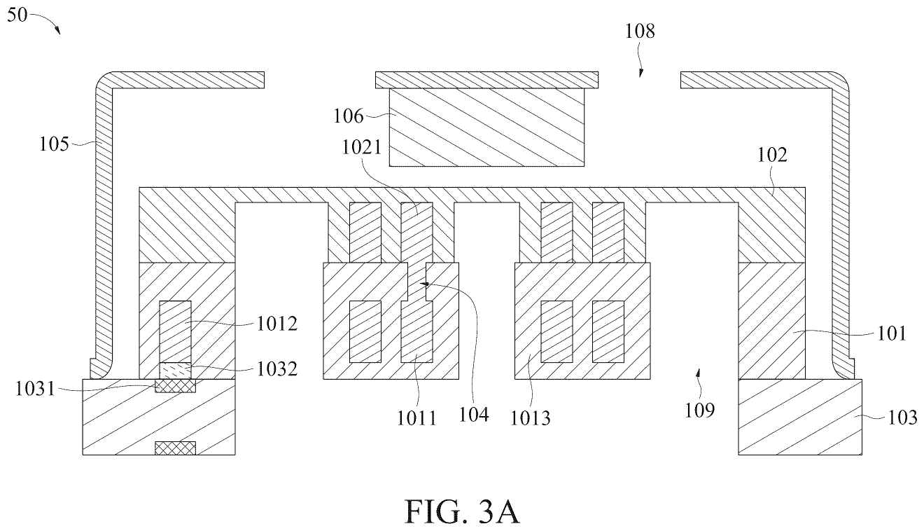

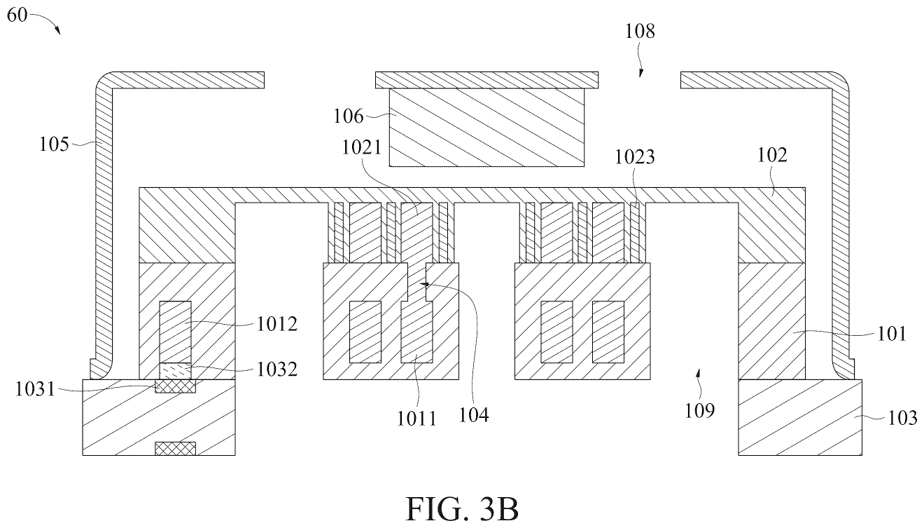

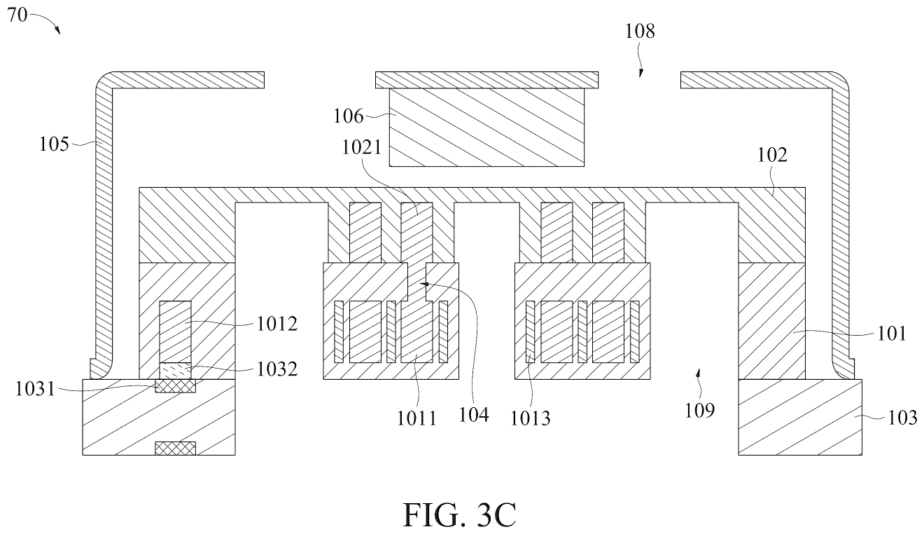

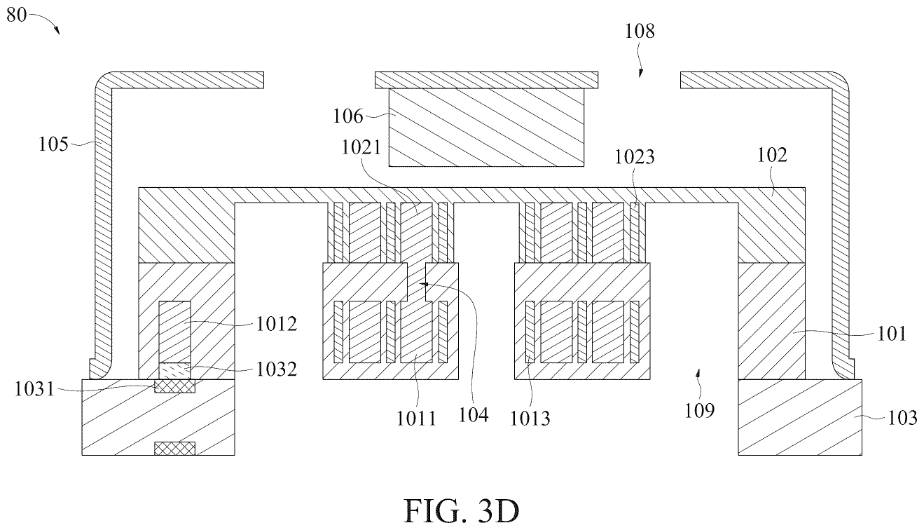

FIG. 3A is a schematic cross-sectional view of a coil module according to Embodiment 5 of the present application, please refer to FIG. 3A. The main difference between a coil module 50 in the present embodiment and the coil module 10 in Embodiment 1 is the packaging mode. The coil module 10 in Embodiment 1 connects the first substrate 101 and the third substrate 103 in a wire bonding mode. In the present embodiment, the coil module 50 electrically connects the pad 1012 of the first substrate 101 and the pads 1031 of the third substrate 103 through solder 1032 in a flip chip mode. Therefore, the second substrate 102 is deployed on the upper surface of the first substrate 101, and the first substrate 101 is deployed on the upper surface of the third substrate 103. When observing the coil module 50 from the top-view perspective, the cavities 109 cannot be observed, and a complete second substrate 102 is observed. When observing the coil module 50 from a bottom-view perspective, the cavities 109 and the second substrate 102 at the bottom part can be observed through the open hole of the third substrate 103. When the coil module 50 is manufactured through this packaging process, the second substrate 102 is closer to the hard magnet 106.

FIG. 3B is a schematic cross-sectional view of a coil module according to Embodiment 6 of the present application, please refer to FIG. 3B. In the present embodiment, a second substrate 102 of a coil module 60 includes a second coil 1021 and second soft magnets 1023. The main difference between the coil module 60 in the present embodiment and the coil module 20 in Embodiment 2 is that flip chip packaging is adopted in the present embodiment, and the configuration mode and application of the second soft magnets 1023 are similar to those in Embodiment 2, which will not be repeated here.

FIG. 3C is a schematic cross-sectional view of a coil module according to Embodiment 7 of the present application, please refer to FIG. 3C. In the present embodiment, a first substrate 101 of a coil module 70 includes a first coil 1011, a pad 1012, and first soft magnets 1013. The main difference between the coil module 70 in the present embodiment and the coil module 30 in Embodiment 3 is that flip chip packaging is adopted in the present embodiment, and the configuration mode and application of the first soft magnets 1013 are similar to those in Embodiment 3, which will not be repeated here.

FIG. 3D is a schematic cross-sectional view of a coil module according to Embodiment 8 of the present application, please refer to FIG. 3D. In the present embodiment, a first substrate 101 of a coil module 80 includes a first coil 1011, a pad 1012, and first soft magnets 1013, and a second substrate 102 includes a second coil 1021 and second soft magnets 1023. The main difference between the coil module 80 in the present embodiment and the coil module 40 in Embodiment 4 is that flip chip packaging is adopted in the present embodiment, and the configuration mode and application of the first soft magnets 1013 and the second soft magnets 1023 are similar to those in Embodiment 4, which will not be repeated here.

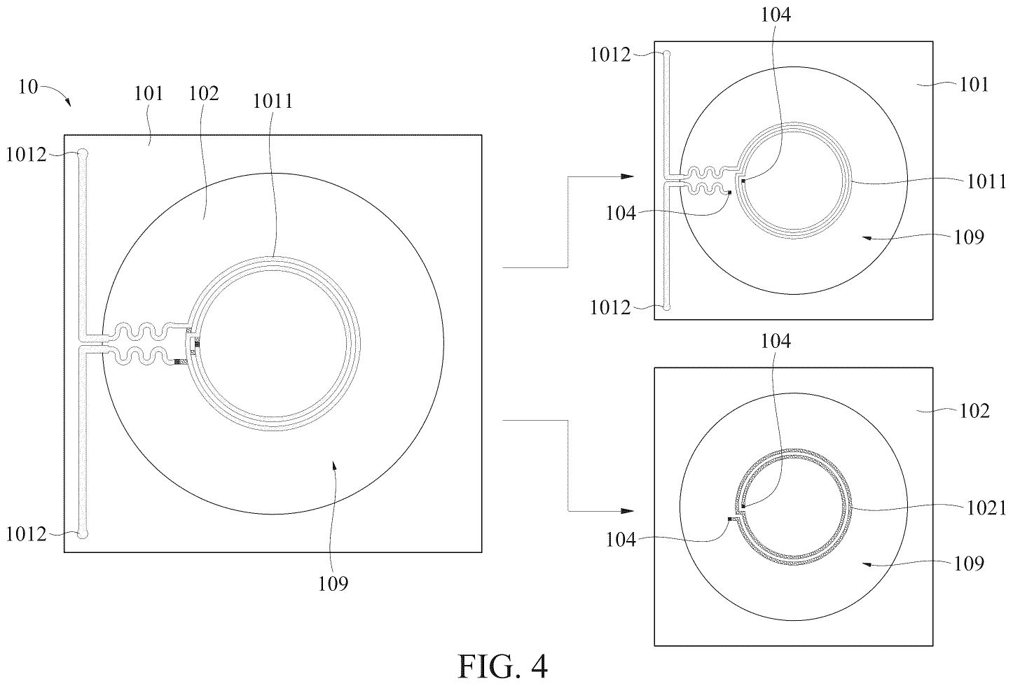

FIG. 4 is a schematic hierarchical view of a coil module according to Embodiment 1 of the present application, please refer to FIG. 4. As shown in FIG. 1B, the first substrate 101 covers above the second substrate 102. The left picture in FIG. 4 is the same as FIG. 1A, and the upper right picture and the lower right picture in FIG. 4 respectively represent the first substrate 101 and the second substrate 102 independently. As shown in the upper right picture in FIG. 4, the first coil 1011 of the first substrate 101 includes the inner circle and the outer circle, the inner circle is connected with the outer circle, a tail end of the outer circle extends towards an upper left part of the first substrate 101 and is connected to the pad 1012, and a tail end of the inner circle is connected to a conductor in the via 104 and is conducted with the second coil 1021. The first substrate 101 at least includes two vias 104, one via 104 is as described above and connects the first coil 1011 and the second coil 1021; and the other via 104 connects a wire on the first substrate 101 to the second coil 1021, and the wire extends towards a lower left part of the first substrate 101 and is connected to the other pad 1012. When a current enters the first coil 1011 from the pad 1012 at an upper left corner of the coil module 10, the current sequentially passes through the first coil 1011, the via 104, the second coil 1021, the other via 104, the wire on the first substrate 101, and the other pad 1012 in a clockwise direction. It is to be noted that a deploying position of the pad 1012 on the first substrate 101 is not limited. As described above, the first substrate 101 is provided with the caves to form the cavities 109, and in the present embodiment, the cavities 109 are deployed in and out of the area surrounded by the first coil 1011. In other embodiments, the shape of the cavities 109 is not limited.

With reference to the lower right picture in FIG. 4, the second coil 1021 of the second substrate 102 includes the inner circle and the outer circle, the inner circle and the outer circle are connected, a tail end of the outer circle is connected to the conductor in the via 104 and connected to the wire on the first substrate 101, a tail end of the inner circle is connected to the conductor in the other via 104, and the second coil 1021 is connected with the first coil 1011. The second substrate 102 is provided with the concave parts to form the cavities 109, and bottom parts of the cavities 109 are the surface of the second substrate 102. Therefore, the second substrate 102 at the bottom parts of the cavities 109 is slightly thinner than the second substrate 102 on the periphery. In addition, in the present embodiment, the first coil 1011 and the second coil 1021 of the coil module 10 have similar shape and are mostly overlapped on horizontal coordinates, so that magnetic forces borne by the surface positions of the first substrate 101 and the second substrate 102 are roughly the same. In other embodiments, the first coil 1011 and the second coil 1021 may have different coil numbers and shapes. In addition, in the present embodiment, the coil module 10 is of a double-layer structure, and the coils are connected with one another through the via 104 in the substrate. In other embodiments, the coil module may be of a multi-layer structure and connected with one another through the via in each layer. In some embodiments, the geometric center of the first coil and the geometric center of the second coil are located on a central axis, and the central axis is perpendicular to the first substrate and the second substrate. For example, the first coil is a large-diameter ring, the second coil is a small-diameter ring, and centers of the two rings are located on the same central axis.

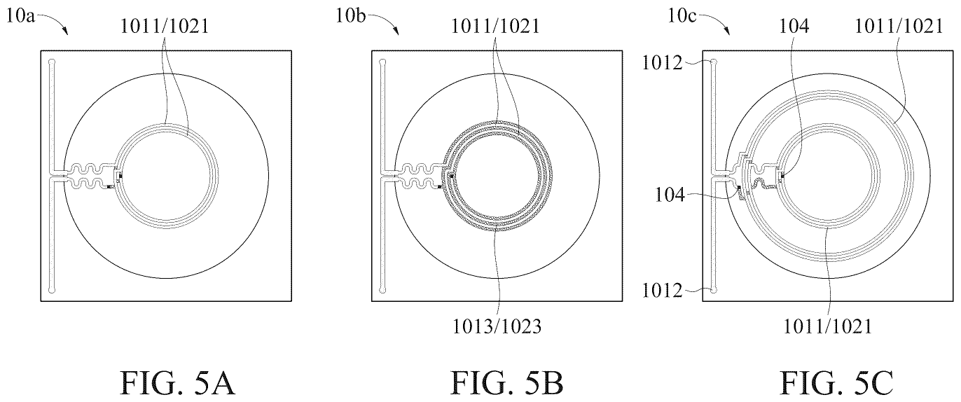

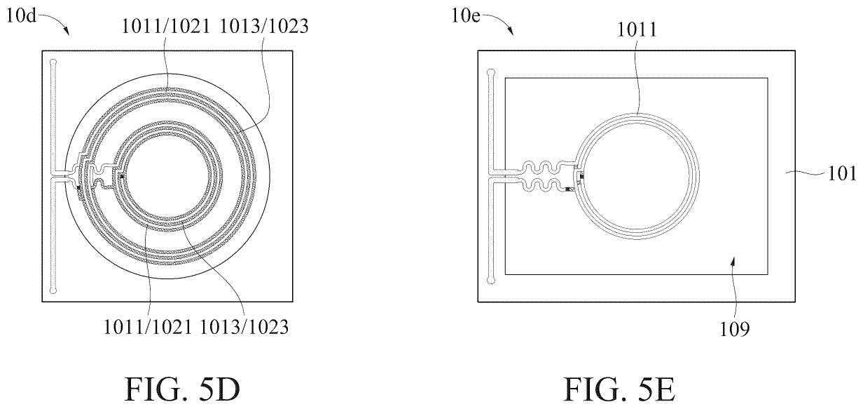

FIG. 5A is a schematic top view of a coil module according to Embodiment 9 of the present application, please refer to FIG. 5A. A coil module 10a in the present embodiment is approximately the same as the coil module 10 in Embodiment 1, and in this case, the first coil 1011 is positioned above the second coil 1021. Alternatively, the coil module 10a in the present embodiment may correspond to the coil module 50 in Embodiment 5, and in this case, the second coil 1021 is positioned above the first coil 1011.

FIG. 5B is a schematic top view of a coil module according to Embodiment 10 of the present application, please refer to FIG. 5B. A coil module 10b in the present embodiment may correspond to the coil module 30 in Embodiment 3 or the coil module 40 in Embodiment 4, in this case, the first coil 1011 is positioned above the second coil 1021, and first soft magnets 1013 are deployed between the first coil 1011. Alternatively, the coil module 10b in the present embodiment may correspond to the coil module 60 in Embodiment 6 or the coil module 80 in Embodiment 8, in this case, the second coil 1021 is positioned above the first coil 1011, and second soft magnets 1023 are deployed between the second coil 1021. Through the first soft magnets 1013 or the second soft magnets 1023, the SPL of the sound produced by the vibration of the second substrate 102 can be improved.

FIG. 5C is a schematic top view of a coil module according to Embodiment 11 of the present application, please refer to FIG. 5C. A coil module 10c in the present embodiment includes a first coil 1011 with four circles, where the configuration of the outermost two circles of the first coil 1011 is approximately the same as that of the coil module 10a in Embodiment 9, an inner circle of the coil module 10c is directly connected with the first coil 1011 and a second coil 1021 through the conductor in via 104, a secondary outer circle of the coil module 10c extends inwards through the wire to form the two innermost circles of the first coil 1011, and the innermost circle of the coil module 10c is connected with the first coil 1011 and the second coil 1021 through the conductor in the via 104. When a current enters the first coil 1011 from the pad 1012 at an upper left corner of the coil module 10c, the current sequentially passes through the outermost circle of the first coil 1011, the secondary outer circle of the first coil 1011, the secondary inner circle of the first coil 1011, the innermost circle of the first coil 1011, the via 104, the innermost circle of the second coil 1021, the secondary inner circle of the second coil 1021, the secondary outer circle of the second coil 1021, the outermost circle of the second coil 1021, the other via 104, the wire on the first substrate 101, and the other pad 1012 in the clockwise direction. The first coil 1011 of the coil module 10c may be configured above the second coil 1021, or, the second coil 1021 is configured above the first coil 1011. In the present embodiment, total harmonic distortion (THD) of the coil module 10c can be improved through multi-circle coil configuration of the coil module 10c. Configuration positions of the inner circle and the outer circle can be considered to meet the requirement for producing different sound frequencies by the coil module 10a, and a resonance characteristic of the second substrate 102; and each coil is configured at an antinode position of resonance waves, and thereby the overall resonance performance of a thin film is improved.

FIG. 5D is a schematic top view of a coil module according to Embodiment 12 of the present application, please refer to FIG. 5D. A coil module 10d in the present embodiment is additionally provided with the first soft magnets 1013 and/or the second soft magnets 1023 on the basis of the coil module 10c in Embodiment 11. Although a manufacturing process of the coil module 10d is relatively complex, the coil module 10d is more optimized in SPL and THD performance compared with the coil module 10a in Embodiment 9.

FIG. 5E is a schematic top view of a coil module according to Embodiment 13 of the present application, please refer to FIG. 5E. The main difference between a coil module 10e in the present embodiment and the coil module 10a in Embodiment 9 is the shape of the cavities 109. The coil module 10a in Embodiment 9 forms annular cavities 109 in combination with the annular first coil 1011 and the annular second coil 1021. In the present embodiment, the cavities 109 are rectangular, and in this case, a sound production vibrating film formed by combining the first substrate 101 and the second substrate 102 is changed into a rectangular shape from a circular shape. Through different shape design of the coils and the cavities 109, the THD performance of the coil module 10e can also be optimized. The first coil 1011 of the coil module 10e may be deployed above the second coil 1021. However, the second coil 1021 may also be deployed above the first coil 1011 (not shown in the figure).

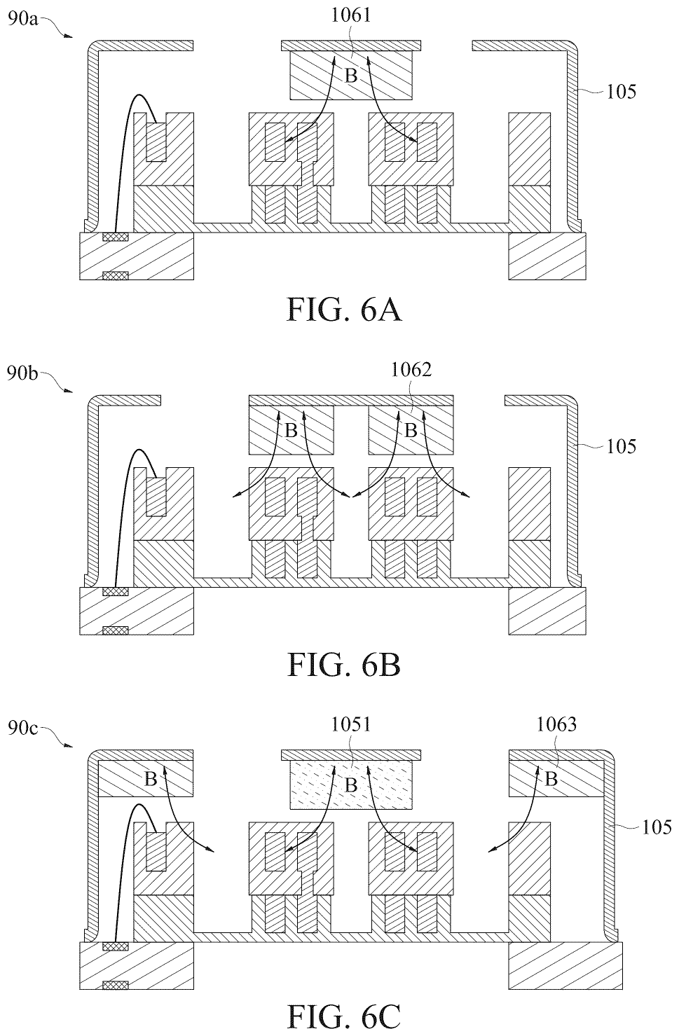

FIG. 6A is a schematic cross-sectional view of a coil module according to Embodiment 14 of the present application, please refer to FIG. 6A. In the present embodiment, a first coil 1011 and a second coil 1021 of a coil module 90a are annular coils, a hard magnet 1061 is cylindrical and is deployed on axes of the annular coils, and therefore an axis of the hard magnet 1061 is perpendicular to the surface of the first substrate 101. As the coils are not deployed right under the axis of the hard magnet 1061, when a closed magnetic field B passes through the first coil 1011 and the second coil 1021, a horizontal component will be caused. According to Lorentz force formula, when a current passes through the first coil 1011 and the second coil 1021, the horizontal component of the magnetic field B causes an electromagnetic force in the vertical direction to the first coil 1011 and the second coil 1021, and the first substrate 101 and the second substrate 102 vibrate up and down. The hard magnet 1061 of the coil module 90a occupies a very small space, so a packaging structure of the coil module 90a is miniaturized.

FIG. 6B is a schematic cross-sectional view of a coil module according to Embodiment 15 of the present application, please refer to FIG. 6B. In the present embodiment, a first coil 1011 and a second coil 1021 of a coil module 90b are annular coils, a hard magnet 1062 is annular, and an axis of the hard magnet is coaxial with axes of the annular coils, and therefore the axis of the hard magnet 1062 is perpendicular to the surface of the first substrate 101, and a diameter of the annular coils may be the same as or different from that of the annular hard magnet 1062. In the present embodiment, the hard magnet 1062 is magnetized through thickness, an upper part and a lower part of the hard magnet are different in polarity; and in some other embodiments, the hard magnet 1062 is radially magnetized, an inner circle and an outer circle of the hard magnet are different in polarity (not shown in the figure), more horizontal component of the magnetic fields may be provided for the first coil 1011 and the second coil 1021, and therefore the up-down vibration amplitude of the first substrate 101 and the second substrate 102 are improved.

FIG. 6C is a schematic cross-sectional view of a coil module according to Embodiment 16 of the present application, please refer to FIG. 6C. In the present embodiment, a first coil 1011 and a second coil 1021 of a coil module 90c are annular coils, a hard magnet 1063 is annular, an axis of the hard magnet is coaxial with axes of the annular coils, and therefore the axis of the hard magnet 1063 is perpendicular to the surface of the first substrate 101. In the present embodiment, the hard magnet 1063 has a large diameter, for example, the hard magnet is deployed on the periphery of an upper surface of the packaging structure, so that the process limitation of the hard magnet 1063 is lower, and the hard magnet 1063 may be made of strong magnet materials, such as sintered neodymium iron boron magnets. A magnetic conductor 1051 is deployed in the center of the upper surface of the packaging structure, and the magnetic conductor 1051 has the function of guiding and concentrating the magnetic lines, so that the magnetic field B can pass through the first coil 1011 and the second coil 1021 to the maximum extent. A material of the magnetic conductor 1051 may be alloy containing iron, cobalt, and nickel, or oxide thereof. In the present embodiment, the lid 105 and the magnetic conductor 1051 are independently deployed. In some other embodiments, the lid 105 is made of magnetic conductive materials, and the magnetic conductor 1051 is a part of the structure of the lid 105.

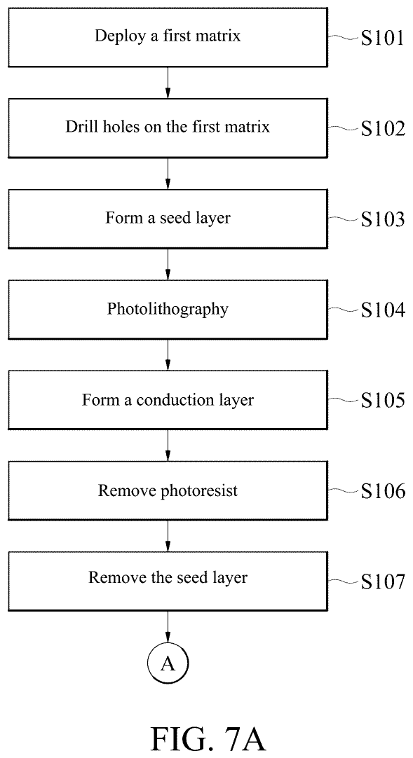

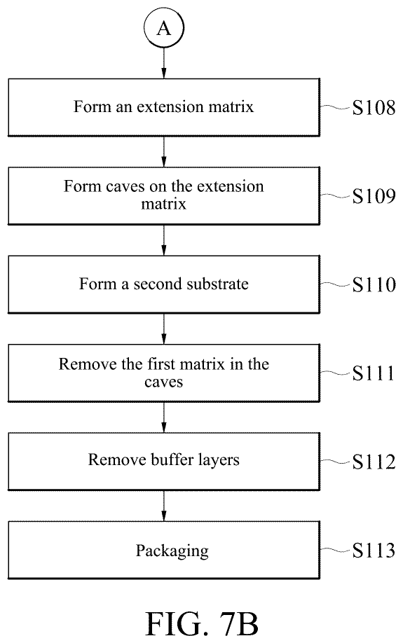

FIG. 7A and FIG. 7B are flowcharts of manufacturing of a coil module according to some embodiments of the present application, please refer to FIG. 7A and FIG. 7B. A manufacturing process of the coil module according to each embodiment of the present application will be described below. In the present embodiment, the manufacturing process of the coil module includes step S101: deploy a first matrix; step S102: drill holes on the first matrix; step S103: form a seed layer; step S104: photolithography; step S105: form a conduction layer; step S106: remove photoresist; step S107: remove the seed layer; step S108: form an extension matrix; step S109: form caves on the extension matrix; step S110: form a second substrate; step S111: remove the first matrix in the caves; step S112: remove buffer layers; and step S113: packaging.

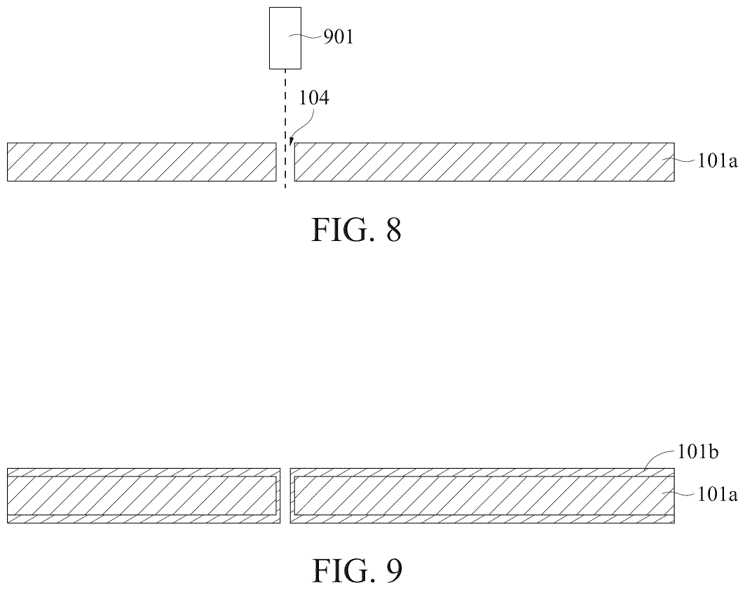

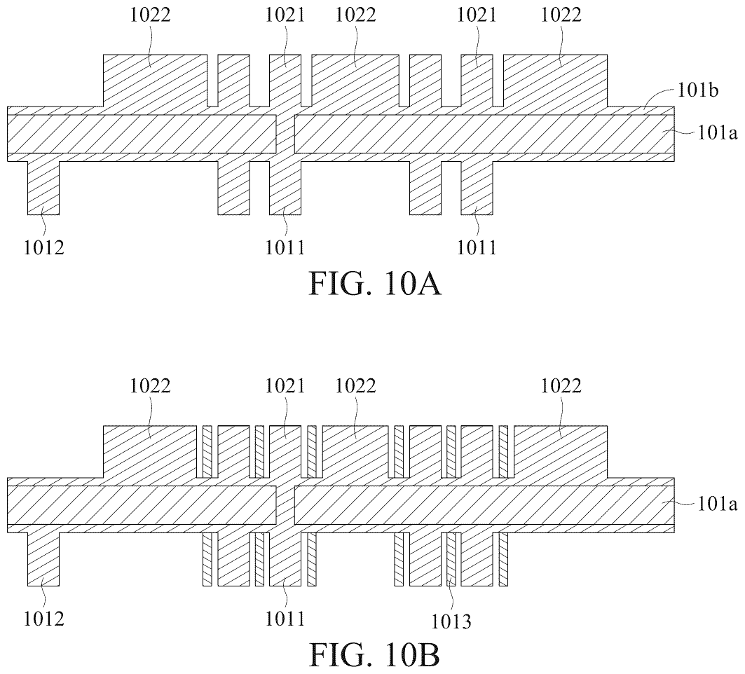

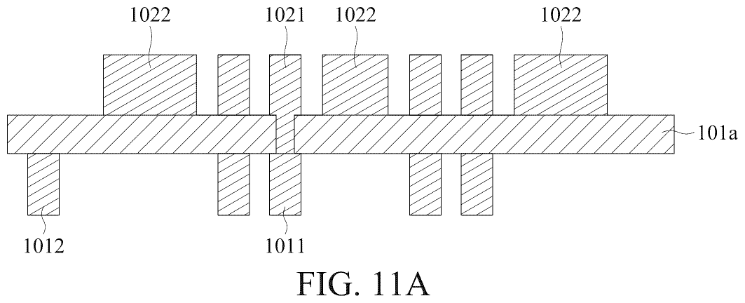

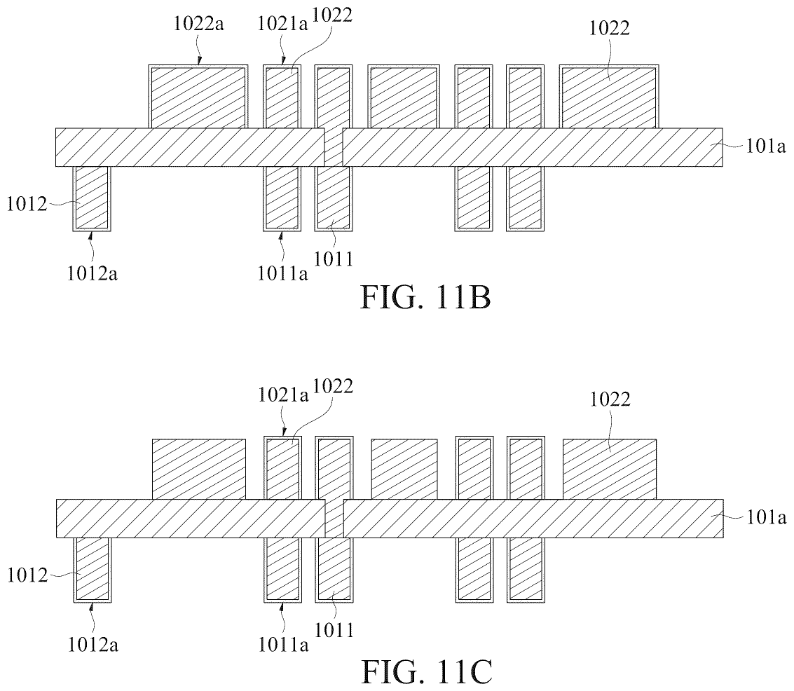

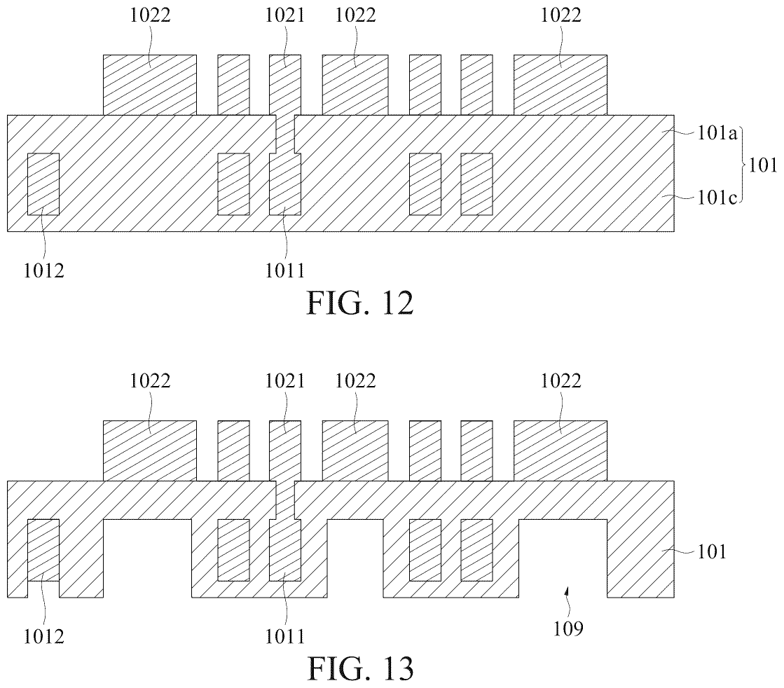

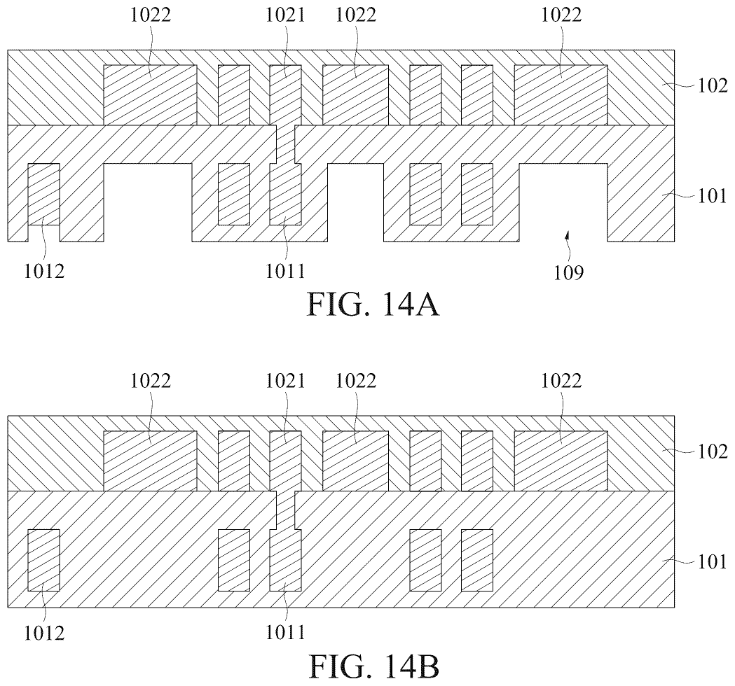

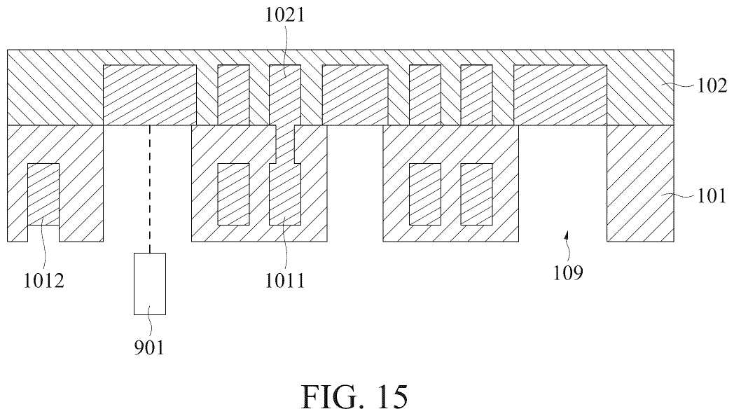

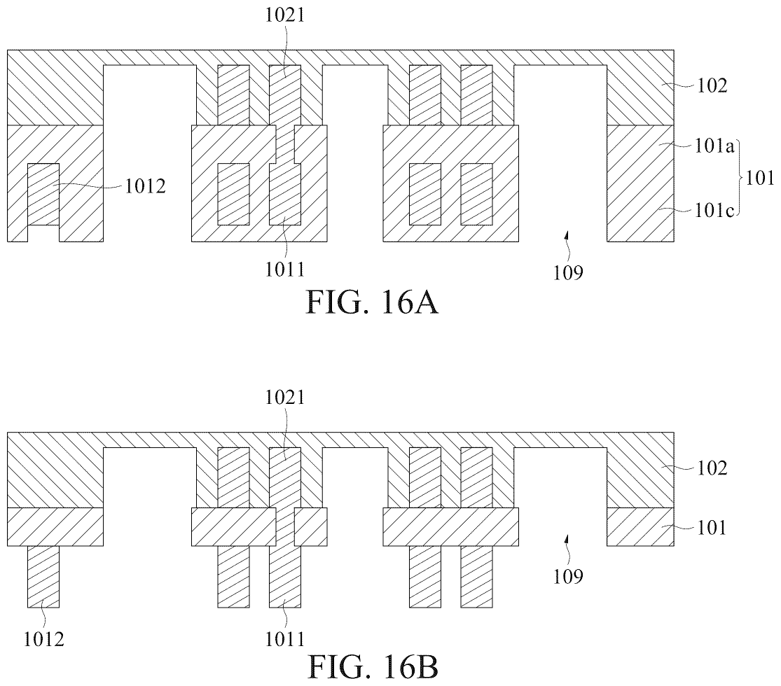

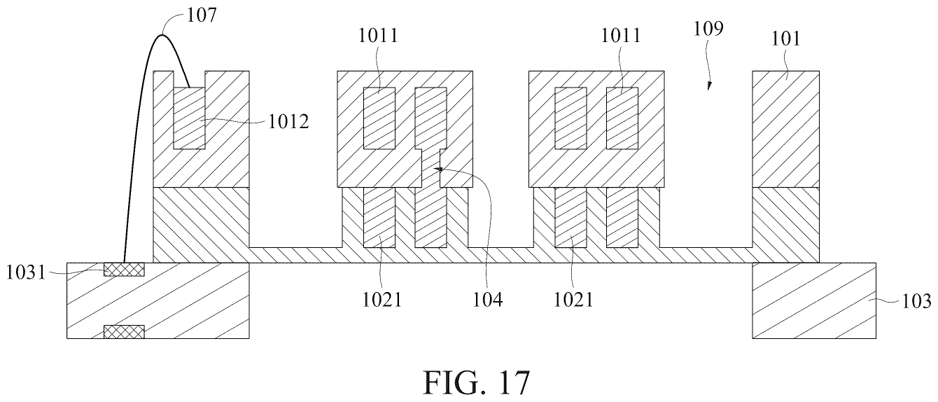

FIG. 8, FIG. 9, FIG. 10A, FIG. 10B, FIG. 11A, FIG. 11B, FIG. 11C, FIG. 12, FIG. 13, FIG. 14A, FIG. 14B, FIG. 15, FIG. 16A, FIG. 16B, and FIG. 17 are schematic cross-sectional views of a manufacturing process of a coil module according to some embodiments of the present application, please refer to each figure in order. Please refer to FIG. 8, FIG. 8 involves step S101: deploy a first matrix; and step S102: drill holes on the first matrix. A material of a first matrix 101a can be selected from the group consisting of silicon, polyimide, rubber, plastic, polymer, resin, wood, ceramic, glass, paper and a combination thereof. In some embodiments, the first matrix 101a is made of a thin film material. In the present embodiment, holes are drilled on the first matrix 101a through a laser 901, and the formed holes are vias 104. The hole forming mode is not limited, for example, laser, chemical etching, ion beams, electron beams, photolithography, or machining may be adopted.

Please refer to FIG. 9, FIG. 9 involves step S103: form a seed layer. A material of a seed layer 101b may be a conductive material, for example, metal, alloy, or conductive polymer. A material of the metal seed layer 101b can be selected from the group consisting of copper, silver, gold, aluminum and a combination thereof. The mode of forming the seed layer 101b (step S103) can be electrodeless electroplating (chemical electroplating), physical vapor deposition, or chemical vapor deposition. The seed layer 101b is beneficial for improving the crystallization or molecular adhesion of the conductive material in subsequent manufacturing processes.

Please refer to FIG. 10A, FIG. 10A involves step S104: photolithography; step S105: form a conduction layer; and step S106: remove photoresist. In the photolithography (step S104), a surface of the seed layer 101b is coated with a photoresist material. The photoresist material forms a patterned structure under the photolithography, and in the step of forming the conduction layer (step S105), a conduction material is deposited on a surface of the patterned structure. The conduction material may be a conductive material, such as metal, alloy, or conductive polymer. The metal conduction material can be selected from the group consisting of copper, silver, gold, aluminum and a combination thereof. The mode of forming the conduction layer (step S105) may be electroplating, electrodeless electroplating (chemical electroplating), physical vapor deposition, or chemical vapor deposition. In the present embodiment, the conduction layers are formed on front and back surfaces of the first matrix 101a. That is, the photolithography (step S104) is carried out to coat the photoresist material on the surface of the seed layer 101b on the front and back surfaces of the first matrix 101a, and form different patterned structures respectively. In the step of forming the conduction layer (step S105), the conduction material is deposited between surfaces of the patterned structures and the via 104. After the photoresist is removed (step S106), different conduction layer structures are formed on the front and back surfaces of the first matrix 101a respectively. In FIG. 10A, the conduction layer structures with continuous patterns are formed on a lower surface of the first matrix 101a, and the conduction layer structures form the first coil 1011 and the pad 1012 respectively. A part of the conduction layer structure of the first coil 1011 is at least formed on the lower surface of the via 104. The conduction layer structures with continuous patterns are formed on an upper surface of the first matrix 101a, and the conduction layer structures form the second coil 1021 respectively. A part of the conduction layer structure of the second coil 1021 is at least formed on the upper surface of the via 104. In addition, buffer layers 1022 are formed outside, between, or inside one or more circles of the second coil 1021. In the present embodiment, the buffer layers 1022 occupy a larger surface area than the second coil 1021.

Please refer to FIG. 11A, FIG. 11A involves step S107: remove the seed layer. In this step, the seed layer 101b is removed by an etching mode, so that the conduction layers form linear first coil 1011 and linear second coil 1021, and the surface of the first matrix 101a is exposed. In some other embodiments, please refer to FIG. 11B, one or more of the first coil 1011, the pad 1012, and the second coil 1021 may be provided with coating films, and the buffer layers 1022 may be provided with protective films 1022a, such as a coating film 1011a, a coating film 1012a, and a coating film 1021a, and protective films 1022a of the buffer layers 1022 shown in FIG. 11B. Materials of the coating films 1011a, 1012a, and 1021a are different from materials of the respective adhesion structures (i.e., the first coil 1011, the pad 1012, or the second coil 1021), and the materials of the coating films 1011a, 1012a, 1021a, and 1022a can be selected from the group consisting of nickel, tin, chromium, gold, silver, zinc and a combination thereof. The protective films 1022a can be selected from the group consisting of photoresist material, polydimethylsiloxane, polyimide, graphene, poly-para-xylylene and a combination thereof. In the present embodiment, the manufacturing method can form the protective films 1022a on surfaces of the buffer layers 1022 firstly, and then one or more of the coating film 1011a, the coating film 1012a, and the coating film 1021a are formed by the manufacturing method. In the present embodiment, please refer to FIG. 11C, the protective films 1022a are removed by the manufacturing method after the coating process is finished.

Please refer to FIG. 12, FIG. 12 involves step S108: form an extension matrix. In this step, an extension matrix 101c is formed on the lower surface of the first matrix 101a, namely a surface where the first coil 1011 is located. The first matrix 101a and the extension matrix 101c jointly form the first substrate 101. The first coil 1011 is enclosed with the first substrate 101. A material of the extension matrix 101c can be selected from the group consisting of silicon, polyimide, rubber, plastic, polymer, resin, wood, ceramic, glass, paper and a combination thereof. In the present embodiment, the first matrix 101a is made of polyimide, and the extension matrix 101c is a photo-imageable coverlay (PIC), so as to form a pattern on a surface of the PIC in a developing mode.

Please refer to FIG. 13, FIG. 13 involves step S109: form caves on the extension matrix. In this step, a developing pattern formed on the surface of the PIC is removed by a lift-off method to form the caves. The caves form a part of the cavities 109. In some embodiments, forming positions of the caves correspond to the positions of the buffer layers 1022. In some embodiments, the pad 1012 may be exposed by developing and lift-off.

Please refer to FIG. 14A, FIG. 14A involves step S110: form a second substrate. In this step, the second substrate 102 is formed on the upper surface of the first matrix 101a, namely a surface where the second coil 1021 and the buffer layers 1022 are located. The second coil 1021 and the buffer layers 1022 are enclosed with the second substrate 102. For example, the second substrate 102 is formed on the upper surface of the first substrate 101 by a spin coating method or a blade coating method. A material of the second substrate 102 can be a polymer, which can be selected from the group consisting of polydimethylsiloxane, polyimide, graphene, poly-para-xylylene and a combination thereof.

Please refer to FIG. 15, FIG. 15 involves step S111: remove the first matrix in the caves. In the present embodiment, the first matrix 101a in the caves is removed through a laser 901, so that the first substrate 101 is completely penetrated, and the formed caves form a part of the cavities 109. The hole forming mode is not limited, for example, laser, chemical etching, ion beams, electron beams, photolithography, or machining may be adopted. It is to be noted that the buffer layers 1022 achieve an effect of preventing laser (or other hole drilling means) from penetrating through the second substrate 102 in the manufacturing process, so that the second substrate 102 is of a complete film-shaped structure to serve as a vibration film.

Please refer to FIG. 16A, FIG. 16A involves step S112: remove buffer layers. In this step, the buffer layers 1022 are removed in an etching mode, so that a plurality of concave parts (positions where the buffer layers 1022 are originally located) are formed in the second substrate 102. The concave parts of the second substrate 102 and the caves of the first substrate 101 form the cavities 109 together.

Please refer to FIG. 17, FIG. 17 involves step S113: packaging. In the present embodiment, the coil module is packaged by a wire bonding type packaging process. The process includes: flipping a composite mold structure formed in step S112, attaching to the third substrate 103, and electrically connecting the pad 1012 of the first substrate 101 and the pad 1031 of the third substrate 103 through the bonding wire 107. The coil module 10 in Embodiment 1 can be formed by covering the lid 105 and the hard magnet 106. A material of the third substrate 103 can be selected from the group consisting of bakelite plate, glass fiber, copper foil, silicon, rubber, plastic, polymer, resin, wood, ceramics, glass, paper and a combination thereof. In some other embodiments, the coil module can be packaged by a flip chip packaging process, which forming the solder 1032, such as a tin ball, on the pad 1012 of the composite mold structure formed in step S112. The composite mold structure is attached to the third substrate 103, and the solder 1032 corresponds to the pad 1031 of the third substrate 103. Finally, the pad 1012 of the first substrate 101 and the pad 1031 of the third substrate 103 are electrically connected by heating (such as a reflow process). The coil module 50 in Embodiment 5 can be formed by covering the lid 105 and the hard magnet 106.

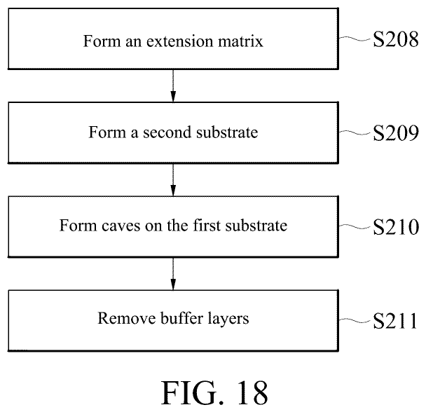

FIG. 18 is a flowchart of manufacturing of a coil module according to some other embodiments of the present application, please refer to FIG. 18. A manufacturing process of the coil module according to some other embodiments of the present application is described below. The manufacturing process of the coil module in the present embodiment is approximately the same as that shown in FIG. 7A and FIG. 7B, and the difference mainly lies in step S108: form an extension matrix; step S109: form caves on the extension matrix; step S110: form a second substrate; step S111: remove the first matrix in the caves; and step S112: remove buffer layers. In the present embodiment, the manufacturing process of the coil module includes step S208: form an extension matrix; step S209: form a second substrate; step S210: form caves on the first substrate; and step S211: remove buffer layers.

Please refer to FIG. 12, FIG. 12 involves step S208: form an extension matrix. In the present embodiment, the first matrix 101a and the extension matrix 101c are both made of polyimide. Therefore, in the present embodiment, the first substrate 101 is completely made of polyimide.

Please refer to FIG. 14B, FIG. 14B involves step S209: form a second substrate. In this step, the second substrate 102 is formed on the upper surface of the first matrix 101a, namely a surface where the second coil 1021 and the buffer layers 1022 are located. The second coil 1021 and the buffer layers 1022 are enclosed with the second substrate 102. For example, the second substrate 102 is formed on the upper surface of the first substrate 101 by a spin coating method or a blade coating method. In this case, the lower surface of the first substrate 101 does not have a part of the cavities 109.

Please refer to FIG. 15, FIG. 15 involves step S210: form caves on the first substrate. In the present embodiment, the first substrate 101 at a specified position is removed through the laser 901, so that the first substrate 101 is completely penetrated, and the formed caves form a part of the cavities 109. In this step, the buffer layers 1022 achieve the effect of preventing laser (or other hole drilling means) from penetrating through the second substrate 102. Therefore, the specified position may correspond to deploying positions of the buffer layers 1022.

Please refer to FIG. 16A, FIG. 16A involves step S211: remove buffer layers. In this step, the buffer layers 1022 are removed in an etching mode, so that a plurality of concave parts (positions where the buffer layers 1022 are originally located) are formed in the second substrate 102. The concave parts of the second substrate 102 and the caves of the first substrate 101 form the cavities 109 together. Please refer to FIG. 16A and FIG. 16B, in some embodiments, the manufacturing method further includes a step of removing the extension matrix 101c after step S211, and only the first coil 1011 and the pad 1012 are reserved. The process of removing the extension matrix 101c can be carried out by laser, chemical etching, laser beams, electron beams, photolithography, or machining.

Therefore, in the manufacturing flow of the coil module in the present embodiment, the cavities 109 are formed at the specified position by a hole drilling process, and this process could not involve the developing and lift-off processes of the PIC film.

Please refer to FIG. 7A and FIG. 7B, it is to be noted that, in some embodiments, step S106 and step S107 may further include the following processes: (1) photolithography; (2) form soft magnets; and (3) remove photoresists. Please refer to FIG. 10B, FIG. 10B involves the above-mentioned processes. In (1) photolithography, the surface of the seed layer 101b is coated with the photoresist material. The photoresist material forms the patterned structure under the photolithography; and in the step of (2) forming the soft magnets, a magnetic material is deposited on the surface of the patterned structure. The magnetic material may be an alloy containing iron, cobalt, and nickel, or an oxide thereof. The soft magnets may be formed by electroplating, electrodeless electroplating (chemical electroplating), physical vapor deposition, or chemical vapor deposition. In the present embodiment, the soft magnets are formed on the front and back surfaces of the first matrix 101a. That is, during (1) photolithography, the surfaces of the seed layers 101b on the front and back surfaces of the first matrix 101a are coated with the photoresist material, and different patterned structures are formed respectively. In the step of (2) forming the soft magnets, the magnetic material is deposited on the surfaces of the patterned structures. After (3) remove photoresist, different soft magnet structures are formed on the front and back surfaces of the first matrix 101a respectively. In FIG. 10B, the soft magnet structures with continuous patterns are formed on the lower surface of the first matrix 101a, and the soft magnet structures form the first soft magnets 1013 respectively. The soft magnet structures with continuous patterns are formed on the upper surface of the first matrix 101a, and the soft magnet structures form the second soft magnets 1023 respectively. After the soft magnets are formed, the manufacturing processes of the coil module can be completed continuously according to steps S107 to S113. Through the manufacturing processes in the present embodiment, the coil modules 20, 30, 40, 60, 70, 80 in Embodiments 2, 3, 4, 6, 7, or 8 can be formed.

Although the present disclosure has been described in considerable detail with reference to certain preferred embodiments thereof, the disclosure is not for limiting the scope of the invention. Persons having ordinary skill in the art may make various modifications and changes without departing from the scope and spirit of the disclosure. Therefore, the scope of the appended claims should not be limited to the description of the preferred embodiments described above.

What is claimed is:

1. A coil module, comprising:
a first substrate, comprising a plurality of caves;
a first coil, embedded into the first substrate;
a second substrate, deployed on a lower surface of the first substrate, wherein the second substrate comprises a plurality of concave parts forming a plurality of cavities with the plurality of caves respectively;
a second coil, embedded into the second substrate; and
a via, embedded into the first substrate, wherein the first coil is electrically connected with the second coil through the via.

2. The coil module according to claim 1, further comprising a third substrate, wherein the third substrate comprises an open hole and a pad, the second substrate is deployed on an upper surface of the third substrate, and a projection range of the open hole on the second substrate covers a range of the plurality of concave parts on the second substrate.

3. The coil module according to claim 1, further comprising a third substrate, wherein the third substrate comprises an open hole and a pad, the first substrate is deployed on an upper surface of the third substrate, and a projection range of the open hole on the first substrate covers a range of the plurality of caves on the first substrate.

4. The coil module according to claim 1, wherein a geometric center of the first coil and a geometric center of the second coil are positioned on a central axis, and the central axis is perpendicular to the first substrate and the second substrate.

5. The coil module according to claim 4, further comprising a third substrate, a lid, and a hard magnet, wherein the first substrate and the second substrate are deployed on the third substrate, the lid is deployed on an upper surface of the third substrate and surrounds the first substrate and the second substrate, the hard magnet is deployed on an inner surface of the lid, and a geometric center of the hard magnet is positioned on the central axis.

6. The coil module according to claim 1, further comprising a first soft magnet embedded into the first substrate, wherein the first soft magnet is deployed inside, outside, or between the first coil.

7. The coil module according to claim 1, further comprising a first soft magnet embedded into the first substrate, wherein the first coil comprises a plurality of first sub-coils, and the first soft magnet is deployed outside, inside, or between the plurality of first sub-coils.

8. The coil module according to claim 1, further comprising a second soft magnet embedded into the second substrate, wherein the second soft magnet is deployed inside, outside, or between the second coil.

9. The coil module according to claim 1, further comprising a second soft magnet embedded into the second substrate, wherein the second coil comprises a plurality of second sub-coils, and the second soft magnet is deployed inside, outside, or between the plurality of second sub-coils.

10. The coil module according to claim 1, wherein the second substrate is a polymer, and a material of the polymer is selected from the group consisting of polydimethylsiloxane, polyimide, graphene, poly-para-xylylene and a combination thereof.

11. The coil module according to claim 10, wherein a material of the first substrate is selected from the group consisting of silicon, polyimide, rubber, plastic, polymer, resin, wood, ceramic, glass, paper and a combination thereof, and the material of the first substrate is different from the material of the second substrate.

12. The coil module according to claim 1, wherein the inner diameter of each of the plurality of concave parts is greater than or equal to the inner diameter of each of the plurality of caves.

13. The coil module according to claim 1, wherein each of the plurality of cavities is formed inside and outside the first coil and the second coil respectively.

14. The coil module according to claim 1, wherein the second coil comprises a plurality of second sub-coils, and each of the plurality of cavities is formed inside the second coil and between the plurality of second sub-coils respectively.

15. The coil module according to claim 1, wherein a surface of the first coil comprises a first coating film, a surface of the second coil comprises a second coating film, and materials of the first coating film and the second coating film are respectively selected from the group consisting of nickel, tin, chromium, gold, silver, zinc and a combination thereof.

16. A coil module, comprising:
a first substrate, comprising a plurality of caves;
a first coil, deployed on an upper surface of the first substrate;
a second substrate, deployed on a lower surface of the first substrate, wherein the second substrate comprises a plurality of concave parts forming a plurality of cavities with the plurality of caves respectively;
a second coil, embedded into the second substrate; and
a via, embedded into the first substrate, wherein the first coil is electrically connected with the second coil through the via.

17. A manufacturing method of a coil module, comprising:
deploying a first matrix;
drilling a hole on the first matrix to form a via;
forming a first conduction layer on a lower surface of the first matrix, wherein the first conduction layer comprises a first coil, and the first coil covers the via;
forming a second conduction layer on an upper surface of the first matrix, wherein the second conduction layer comprises a second coil and a buffer layer, and the second coil covers the via;
forming an extension matrix on the lower surface of the first matrix to cover the first coil, and forming a first substrate together with the first matrix;
forming a second substrate on an upper surface of the first substrate;
drilling a hole on the first substrate at a position corresponding to the buffer layer; and
removing the buffer layer.

18. The manufacturing method according to claim 17, wherein after the step of forming the second conduction layer, the method further comprises:
forming a protective film on a surface of the buffer layer;
forming a coating film on surfaces of the first conduction layer and the second conduction layer; and
removing the protective film.

19. The manufacturing method according to claim 17, wherein after the step of removing the buffer layer, the method further comprises: removing the extension matrix.

20. The manufacturing method according to claim 17, wherein a plurality of buffer layers are provided and are respectively deployed inside and outside the second coil.

21. The manufacturing method according to claim 17, wherein the first coil further comprises a first pad, and after the step of removing the buffer layer, the manufacturing method further comprises:
providing a third substrate, wherein the third substrate comprises an open hole and a second pad;
fixing the first substrate to the third substrate, wherein a projection range of the open hole on the first substrate covers a range of the first substrate subjected to hole drilling treatment; and
connecting the first pad and the second pad by flip chip.

22. The manufacturing method according to claim 17, wherein the first coil further comprises a first pad, and after the step of removing the buffer layer, the manufacturing method further comprises:
providing a third substrate, wherein the third substrate comprises an open hole and a second pad;
fixing the second substrate to the third substrate, wherein a projection range of the open hole on the first substrate covers a range of the first substrate subjected to hole drilling treatment; and
connecting the first pad and the second pad by wire bonding.
